(19) United States
(12) Patent Application Publication
(10) Pub. No.: US 2008/0066263 A1
(43) Pub. Date: Mar. 20, 2008

(54) Railway Car Pivot Assembly

(76) Inventors: Shaun Richmond, Frankfort, IL (US); Jonathan A. Preston-Thomas, Chelsea (CA); Michael A. Krzyzanowski, Ottawa (CA); Liam M. Roney, Alberta (CA); Ronald Koopman, Kemptville (CA)

Correspondence Address: BAKER BOTTS L.L.P., 2001 ROSS AVENUE, SUITE 600, DALLAS, TX, 75201-2980, US

(21) Appl. No.: 11/749,244

(22) Filed: May 16, 2007

Related U.S. Application Data
(60) Provisional application No. 60/802,804, filed on May 23, 2006.

(51) Int. Cl. E05D 7/08

(52) U.S. Cl. 16/379

(57) ABSTRACT

According to one embodiment of the present disclosure, a railway car pivot assembly comprises an annular bushing formed with a round-shaped hole and an elongated pivot pin that extends through the hole for rotational movement within. The pivot pin has a flange for releasable securement to an end door of a conventional railway car. The annular bushing is coupled to the railway car via a swivel coupler that provides for orthogonal rotation of the annular bushing relative to the railway car.

### RELATED APPLICATIONS

This application claims the benefit of priority under 35 U.S.C. §119(e) of U.S. Provisional Application Ser. No. 60/802,804, filed May 23, 2006, and entitled “RAILWAY CAR PIVOT ASSEMBLY.”

### TECHNICAL FIELD OF THE DISCLOSURE

This disclosure relates generally to pivot assemblies, and more particularly, to a pivot assembly that may be used in conjunction with an end door of a railway car.

### BACKGROUND OF THE DISCLOSURE

The railway system has been known to provide a relatively efficient means of transporting cargo from one location to another. To facilitate movement of cargo by railway, various differing types of railway car designs have been implemented that are uniquely suited for storage and transport of their respective cargo. One particular type of railway car comprises an elongated box-like structure having a floor, sidewalls, a top wall, and two ends wherein at least one opening is provided for insertion and removal of cargo from the railway car. To provide for selective enclosure of this opening, a pair of end doors may be provided that are movable from an open position to a closed position.

### SUMMARY OF THE DISCLOSURE

According to one embodiment of the present disclosure, a pivot assembly generally includes an annular bushing that couples a pivot pin to a swivel coupler. The pivot pin is fixedly coupled to a first flange having a surface that is generally perpendicular to an axis of the pivot pin. The pivot pin extends through a round-shaped hole in the annular bushing such that the axis of the angular bushing is maintained in fixed alignment with the axis of the pivot pin. The swivel coupler generally includes an annular ring that couples the annular bushing to a second flange. The annular ring is formed of a resilient material for rotation of the second flange along an axis that may be orthogonal to the axis of the pivot pin.

Some embodiments of the present disclosure may provide numerous technical advantages. A particular technical advantage of one embodiment may include a pivot assembly that may be used in conjunction with a railway car. The pivot assembly may have a relatively low profile so as not to cause an obstruction for cargo that may be moved to and from the railway car. Moreover, cargo that shifts during impact as a number of railway cars are coupled together and during transit will be less likely to contact the pivot assembly, thereby avoiding damage to the pivot assembly and/or cargo (e.g., automobiles). That is, the height of the pivot assembly, while mounted on a railway car, does not protrude an undue distance above or below the end door or top wall of the railway car respectively.

Another technical advantage that may be provided by the present disclosure includes a pivot assembly for an end door of a conventional railway car that requires relatively little adjustment following initial installation. The orthogonal movement provided by the swivel coupler enables installation on end doors having irregularities that may cause the end door to rotate about a generally non-vertical arcuate path. Thus, the orthogonal movement provided by the swivel coupler makes alignment of the pivot axis less important during assembly, and provides a “margin” of error during assembly of the car components (e.g., roof and doors). This is helpful in instances where the hinge may be permanently pitched due to wear or bending caused by damage to the car components or incorrect assembly of the hinge and/or door.

Another technical advantage of particular embodiments of the present disclosure includes a nylon annular bushing that provides for lube-free slip contact of the pivot hinge when assembled with the roof and door of the railcar. The annular bushing also provides a flexible interface between components of the hinge that are attached to the door and those that are attached to the hood of the railcar.

While several specific advantages have been disclosed hereinabove, it will be understood that various embodiments may include all, some, or none of the previously disclosed advantages. Other technical advantages may become readily apparent to those skilled in the art of railway car design and usage.

### BRIEF DESCRIPTION OF THE DRAWINGS

A more complete understanding of embodiments of the disclosure will be apparent from the detailed description taken in conjunction with the accompanying drawings in which:

FIG. 1 is a perspective view of a railway car having a pair of end doors on which one embodiment according to the teachings of the present disclosure may be implemented;

FIG. 2A is a partial plan view of the railway car of FIG. 1, shown with the end doors in a partially open position;

FIG. 2B is a partial perspective view of the railway car of FIG. 1, shown with end doors in the closed position;

FIG. 3 is a partial perspective view of a prior art pivot assembly configured on the railway car of FIG. 1;

FIG. 4 is a partial perspective view of a pivot assembly according to one embodiment of the present disclosure that is configured on the railway car of FIG. 1;

FIG. 5 is a partial elevational view of the embodiment of FIG. 4;

FIG. 6 is a partial elevational view of the embodiment of FIG. 5 in which the swivel assembly has been rotated orthogonally with respect to the pivot pin;

FIG. 7 is an exploded view of the embodiment of FIG. 4;

FIG. 8 is a bottom perspective view showing various components that may be removed from the embodiment of FIG. 4 while the pivot assembly is configured on the railway car of FIG. 1;

FIG. 9 is a partial elevational view of the embodiment of FIG. 4 showing an optional seal that may be implemented according to the teachings of the present disclosure;

FIG. 10 shows a series of actions that may be performed to implement a pivot assembly of the present disclosure; and

FIGS. 11A and 11B illustrates a partial view, with portions broken away, of a pivot assembly on a railway car, according to the teachings of the present disclosure.

### DETAILED DESCRIPTION OF EXAMPLE EMBODIMENTS

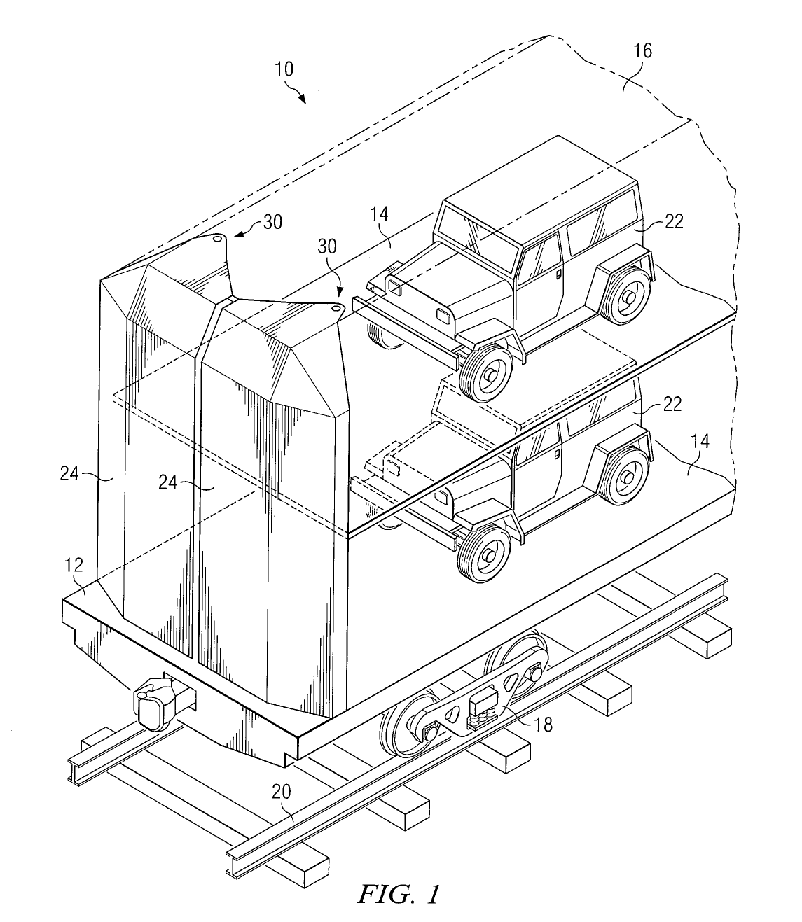

FIG. 1 shows one embodiment of a typical railway car 10 that may be configured for storage and/or transport of cargo. The railway car 10 generally includes a floor 12, a pair of sidewalls 14, and a top wall 16. The railway car 10 may also have trucks 18 configured beneath the floor 12 for use of the railway car 10 on railway tracks 20. This particular railway car 10 is configured for the transportation of automobiles 22, however, railway cars 10 of this nature may be used to store and/or transport any suitable type of cargo. Access to cargo contained in the railway car 10 may be provided by a pair of end doors 24 configured on the end portion of the railway car 10. Each of the end doors 24 may be rotatable about a pivot assembly 30 to provide access to cargo stored inside. This particular configuration in which access to cargo is provided through the end portion of the railway car 10 may be generally well suited for insertion and removal of particular types of cargo, such as automobiles 22.

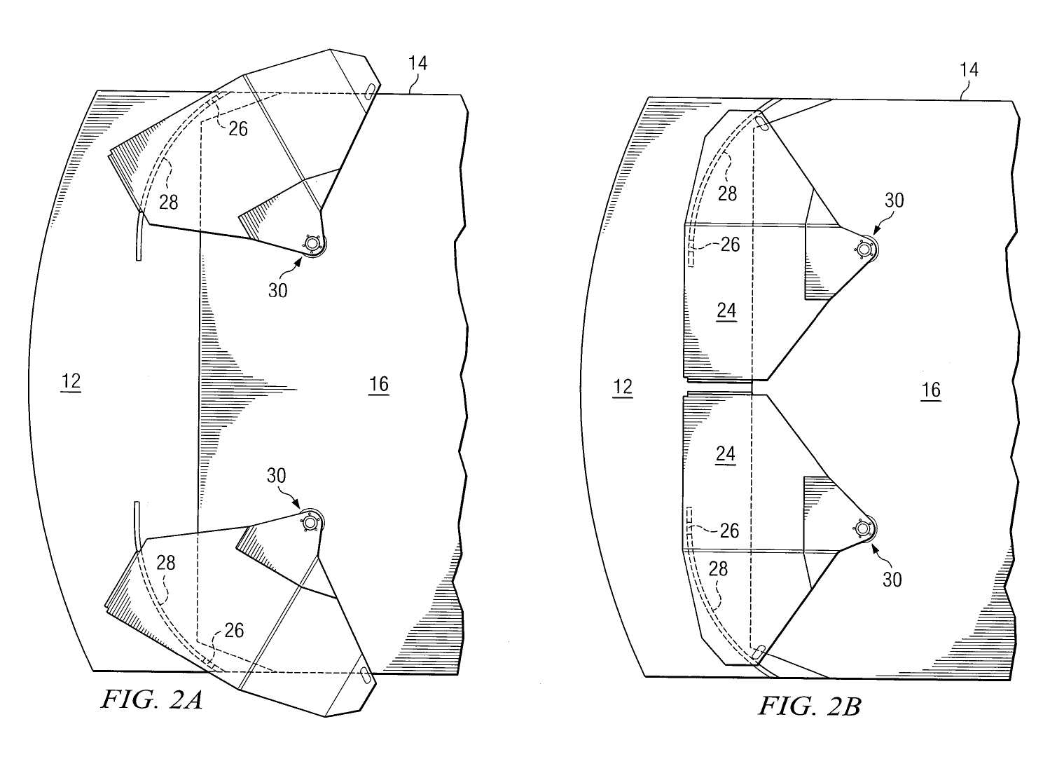

With reference to FIGS. 2A and 2B, the railway car pivot assembly 10 is shown pivotally coupling the end doors 24 to the railway car 10. Each of the end doors 24 are rotatable about a generally vertical axis in order to allow the end door 24 to rotate from a partially open position as shown in FIG. 2A to a closed position as shown in FIG. 2B. Support for each of the end doors 24 may be provided by a roller 26 that is adapted to move through an arcuate depression 28 during the opening or closing operation. Thus, the pair of end doors 24 provide selective access to the inside of the railway car 10 in an easily accessible manner.

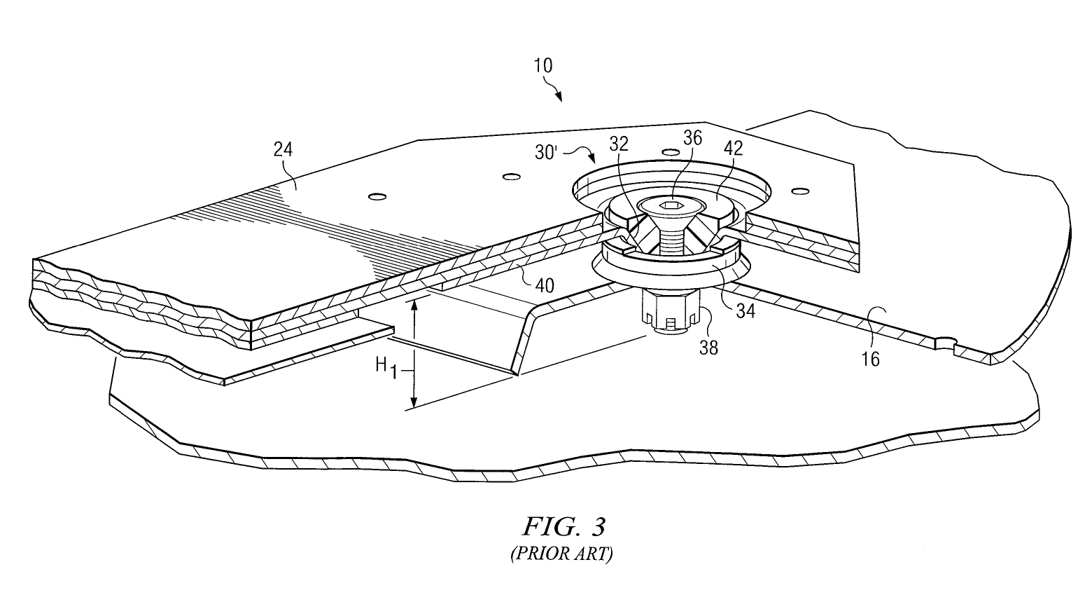

FIG. 3 is an enlarged, partial view of the railway car 10 showing the arrangement of a prior art pivot assembly 30′ that is configured on the railway car 10. Prior art pivot assembly 30′ generally includes a cone-shaped pivoting member 32 that rests on a generally ring-shaped seat 34 and is confined to seat 34 using a bolt 36 having an associated nut 38. Cone-shaped pivoting member 32 has a flange 40 that is coupled to the end door 24 such that the end door 24 may rotate freely along an axis formed by the bolt 36. The prior art pivot assembly 30′ may also have a ring-shaped resilient member 42 that is disposed between the bolt 36 and cone-shape member 32. The prior art pivot assembly 30′ preferably has a relatively short height profile H₁ to not form an obstruction for the insertion or removal of cargo, such as automobiles.

The ring-shaped resilient member 42 provides for movement of the prior art pivot assembly 30′ in an angular direction that may be orthogonal to the pivot assembly's natural direction of rotation. The pivot assembly's natural direction of rotation generally refers to angular movement along an axis of the bolt 36 that in this particular case, is in a generally vertical orientation. The ring-shaped resilient member 42 is generally deformable to allow angular rotation along an axis orthogonal to the pivot assembly's natural direction of rotation. Although the end doors 24 may provide a viable mechanism for selective access to the inside of the railway car 10, shifting of various portions of the railway car 10 relative to one another may cause adverse angular forces to be placed on the pivot assembly. For example, the sidewalls 14 of the railway car 10 may shift relative to the top wall 16 such that rotational movement orthogonal to the pivot assembly's natural direction of rotation may be encountered. Additionally, the floor 12 of the railway car 10 may have an uneven surface that causes rotational movement orthogonal to the natural rotation of the prior art pivot assembly 30′ when the end door 24 is being opened or closed. As yet another example, vibration caused by movement of the railway car 10 may cause rotational movement of the pivot assembly in a direction orthogonal to the pivot assembly's natural direction of rotation.

Although the prior art pivot assembly 30′ does provide angular movement orthogonal to its natural direction of rotation while having a relatively low height profile H₁, its reliability and overall serviceable life have been generally less than desirable. For example, angular movement orthogonal to the pivot assembly's natural direction of rotation causes highly centralized compression forces to be placed upon various portions of the ring-shaped resilient member 42. These forces have caused the ring-shaped resilient member 42 to fail often, thus necessitating frequent maintenance and/or replacement. To compensate for gradual degradation of the resilient member 42, the prior art pivot assembly 30′ may have required frequent adjustment by using a twisting action of nut 38.

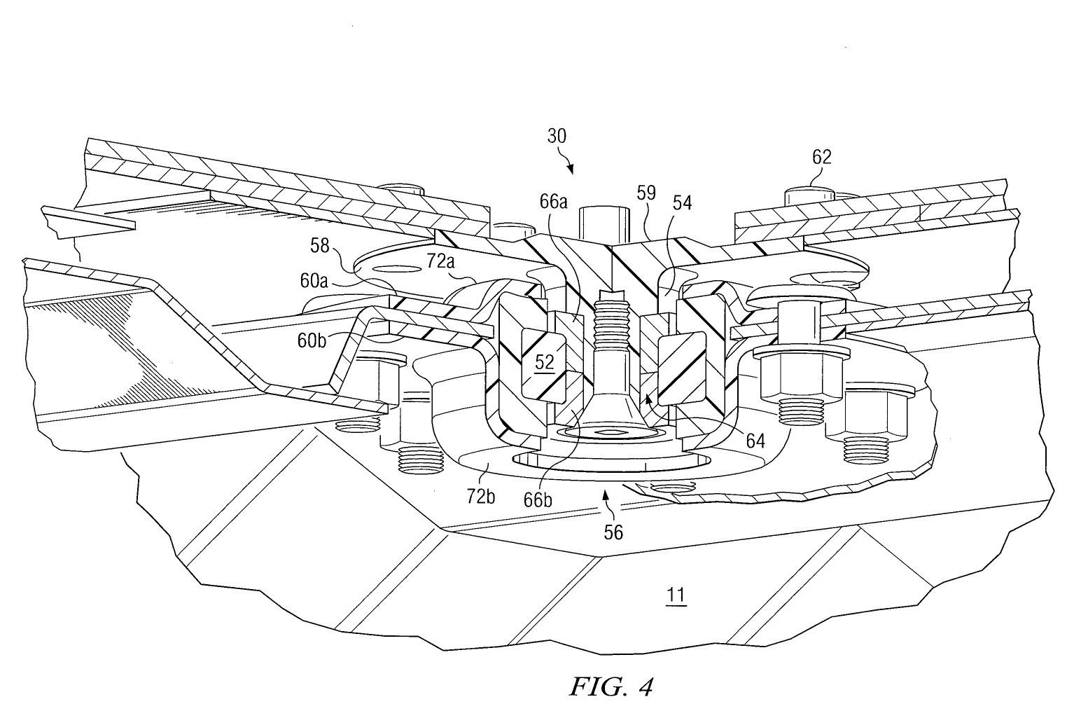

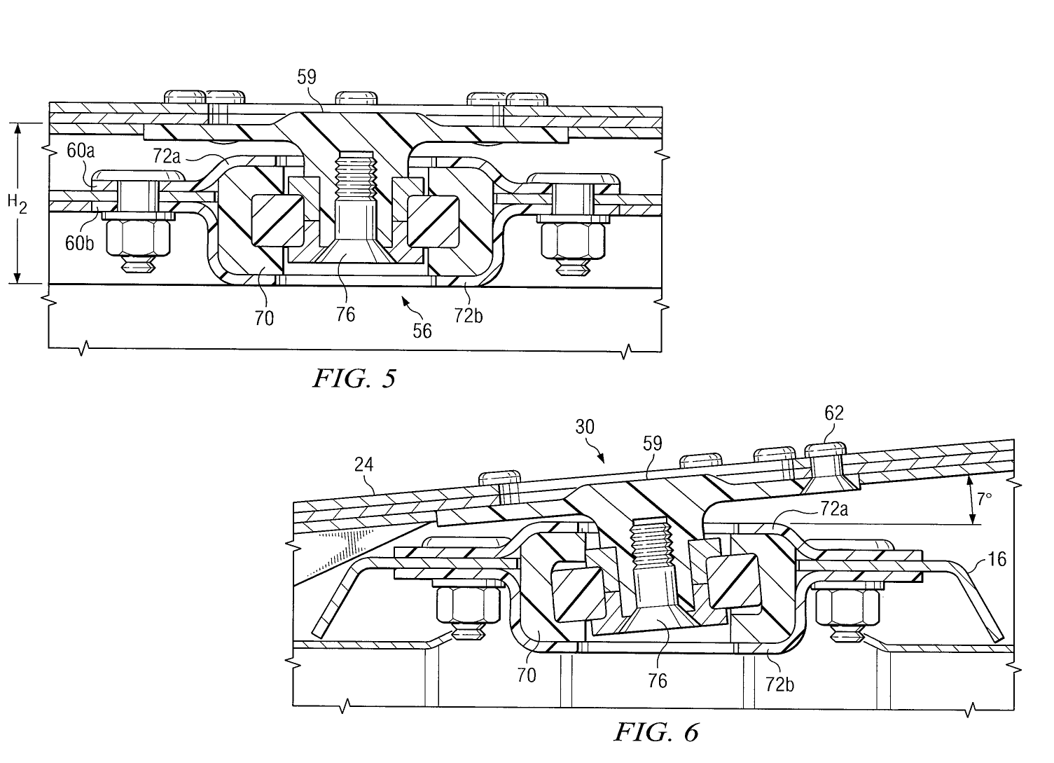

FIG. 4 shows one embodiment of a pivot assembly 30 that may provide a solution to the previously described problems as well as other problems associated with known pivot assemblies, such as the prior art pivot assembly 30′ described above. The pivot assembly 30 generally includes an annular bushing 52 which is rotatingly coupled to a pivot pin 54 and a swivel coupler 56. The pivot pin 54 is integrally formed with a flange 58 having a surface that is generally perpendicular to an axis of the pivot pin 54. The swivel coupler 56 includes an encasement structure 72 (e.g. See FIG. 5). The encasement structure 72 may include an upper encasement portion 72a and an upper flange portion 60a. Upper flange portion 60a is coupled with flange 58 such that flange 58 may rotate freely relative to swivel coupler 56 along an axis of the pivot pin 54. As will be described in greater detail below, upper flange portion 60a may also be able to rotate in an annular direction that may be orthogonal to the axis of the pivot pin 54. The pivot assembly 30 may provide an easily serviceable, retrofit-type replacement for existing pivot assemblies, or for implementation with new end door designs.

Flange 58 and encasement structure 72 may evenly distribute forces exerted by pivot assembly 30 over end door 24 and top wall 16 respectively, which may be generally formed of relatively thin sheet metal material. In one embodiment, flange 58 may be interconnected to end door 24 and upper flange portion 60a may be interconnected to top wall 16 of railway car 10. In one embodiment, flange 58 may have a reinforcement portion 59 integrally formed on its upper surface and coaxially aligned with the pivot pin 54 for distributing forces from the pivot pin 54 to the flange 58. The flange 58 may be interconnected to the end door 24 using any suitable attachment mechanism. In one embodiment, flange 58 is interconnected to the end door 24 using rivets 62. In other embodiments, flange 58 may be interconnected to end door using other attachment mechanisms, such as huck bolts. The pivot pin 54, reinforcement portion 59, and flange 58 may be integrally formed in one piece from any suitable material, such as metal, plastic, or plastic composite material.

Rotational movement of the pivot assembly 30 along the axis of the pivot pin 54 may be provided by annular bushing 52. The pivot pin 54 extends through a round-shaped hole 64 in annular bushing 52 for rotational movement of the annular bushing 52 along the axis of the pivot pin 54. Thus, the annular bushing 52 may freely rotate around pivot pin 54 while preventing generally vertical movement or lateral movement of flange 58 relative to encasement structure 72. In one embodiment, the annular bushing 52 may be formed of a thermoplastic material. Certain embodiment incorporating an annular bushing may provide an advantage due to its relatively good resistance to corrosion that may be inherent in other metallic materials. Corrosion resistance of the annular bushing 52 may further serve to abate inherent flaking of rust that may inadvertently fall onto objects stored within the inside of the railway car 10. In another embodiment, the thermoplastic material may comprise a nylon material, such as “nylon 66” or other suitable material. “Nylon 66” exhibits good heat resistance, good chemical resistance, and relatively good density and toughness making it suitable for use as a material from which the annular bushing 52 is formed. In other embodiments, annular bushing 52 may be formed of Delrin™, Teflon™, ultra high molecular weight (UHMW) plastic, brass, bronze, or other suitable plastic, composite, or metal.

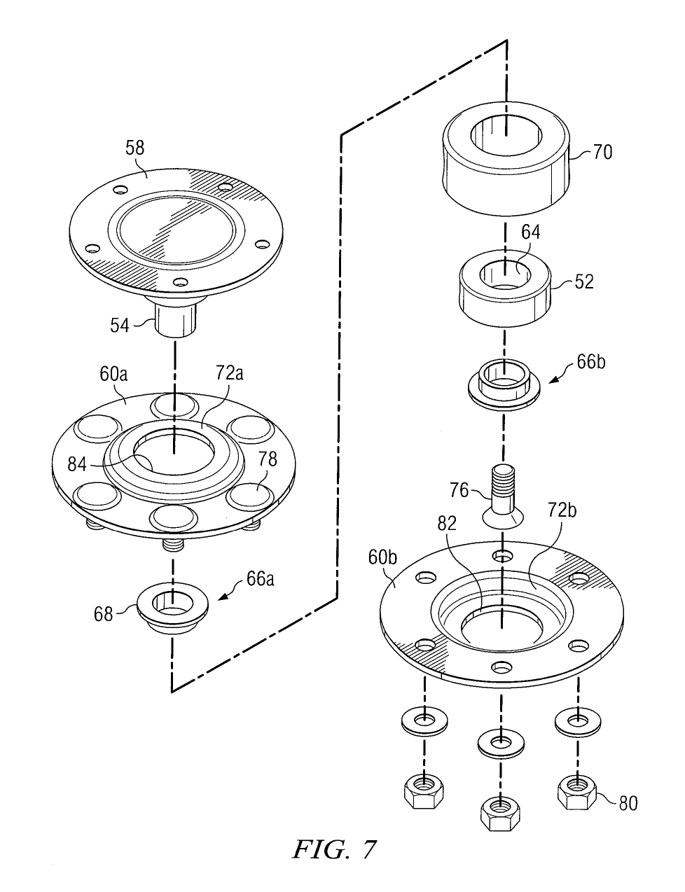

The pivot pin 54 may include a removable bearing 66 that provides a contact surface for the annular bushing 52. Due to surface wear generally associated with moving parts having friction contact, the removable bearing 66 may be removable in order to provide for periodic maintenance and/or replacement as needed. The removable bearing 66 may be secured in place by a bolt 76. The removable bearing 66 may have an upper bearing portion 66a and a lower bearing portion 66b to facilitate placement in the hole 64 of the annular bushing 52. The upper bearing portion 66a may have any length relative to the lower bearing portion 66b such that the combined lengths may encompass the annular bushing 52. In one embodiment, the upper 66a and lower 66b bearing portions have generally equivalent length. In one embodiment, lobes 68 (FIG. 7) may be included on both upper 66a and lower 66b bearing portions to inhibit generally vertical movement of the annular bushing 52 relative to the bearing 66 along the pivot pin 54 axis. Although the bearing 66 is formed of two pieces to facilitate insertion and removal from the annular bushing 52, the bearing 66 may be formed of one piece if the lobes 68 are not implemented. In an alternate embodiment, the upper bearing portion 66a may be integrally formed with the pivot pin 54 such that only the lower bearing portion 66b may be removed from the pivot pin 54.

The bearing 66 may be formed of any material that may not exhibit undue wear during normal use. In one embodiment, the bearing may be formed of a metallic material, such as a steel or copper alloy. In one embodiment, the bearing 66 may be made of “nylon 66” or other materials such as described above. Although the annular bushing 52 and removable bearing 66 are disclosed and shown having friction contact surfaces, it will be appreciated by those skilled in the art that other rotational bearing mechanisms such as ball bearing or roller bearing mechanisms may be utilized with the teachings of the present disclosure.

The annular bushing 52 is coupled to upper flange portion 60a through the swivel coupler 56. The swivel coupler 56 allows the pivot assembly 30 to rotate in a direction that may be orthogonal to the natural rotational direction of the pivot assembly 30 for reasons described above. The natural rotational direction of the pivot assembly 30 may refer to rotational movement about the axis of the pivot pin 54. The pivot assembly 30 may be configured on the railway car 10 such that the end door 24 may rotate freely from the open position to the closed position generally along the axis of the pivot pin 54, which is generally vertical in orientation. Hence, the natural rotation of the end door 24 about the pivot assembly 30 may be referred to as yaw movement. However, orthogonal rotation of the pivot assembly 30 may be encountered if the end door 24 rotates along an arbitrary horizontal axis due to shifting or movement of the various portions of the railway car 10 relative to one another. This rotation about an arbitrary horizontal axis may be referred to as pitch, or roll movement. General mis-alignment of the top wall 16 relative to the end door 24 may also yield an overall angular orientation that causes pitch or roll movement of the pivot assembly 30. Thus, the swivel coupler 56 may provide rotational movement in an angular direction that may be orthogonal to the natural rotational direction of the pivot assembly 30.

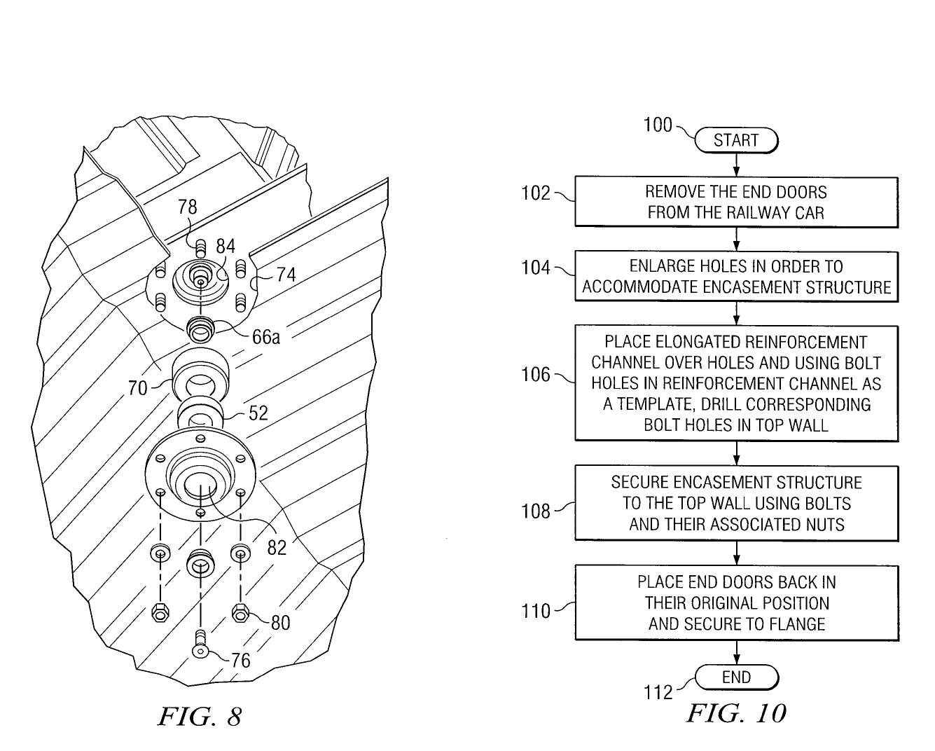

FIG. 5 shows a cut-away elevational view of the pivot assembly 30 of FIG. 4. The swivel coupler 56 generally includes an annular ring 70, an encasement structure 72 that is integrally formed with upper flange portion 60a, and a lower encasement portion 72b that is integrally formed with a lower flange portion 60b. The annular ring 72 is made of a resilient material such that upper flange portion 60a may rotate in a direction orthogonal to the axis of the pivot pin 54. It should be recognized that in particular embodiments, upper flange portion 60a and lower flange portion 60b may be separate components coupling upper encasement portion 72a and lower encasement portion 72b, respectively. This particular embodiment provides removable securement of the encasement structure 72 to the railway car 10 by sandwiching a portion of the top wall 16 between upper 72a and lower 72b flange portions during assembly. A hole 74 (FIG. 8) may be provided in the top wall 16 of the railway car 10 for placement of the encasement structure 72 therethrough. In one embodiment, the upper encasement portion 72a and upper flange portion 60a may be integrally formed from any suitable material, such as metal, plastic, or plastic composite material. In another embodiment, the lower encasement portion 72b and lower flange portion 60b may be integrally formed from any suitable material, such as metal, plastic, or plastic composite material.

The annular ring 70 may have a shape that generally conforms to the shape of the encasement structure 72 and annular bushing 52. In other embodiments, the annular ring 70 only fills a portion of the cavity formed by the encasement structure 72 and annular bushing 52 such that any un-filled portions (e.g., clearance or tolerances) may be dimensioned to predetermined sizes in order to allow the desired orthogonal movement of the pivot assembly 30. The annular ring 70 serves to urge the annular bushing 52 toward the central portion of the cavity formed by the encasement structure.

Upper 72a and lower 72b encasement portions each have a particular height such that the annular ring 70 may be encased inside. In the particular embodiment shown, the height of the lower encasement portion 72b is longer than the upper encasement portion 72a. In this manner, the overall height H₂ of the pivot assembly 30 may be maintained within an acceptable level. In other embodiments, the upper encasement portion 72a may have any height relative to the lower encasement portion 72b such that the annular ring 70 may be securely confined inside the encasement structure 72.

The annular ring 70 may be formed of any suitable resilient material that biases the annular bushing 52 toward the central portion of the encasement structure. In this manner, orthogonal forces placed on the pivot assembly 30 allow the annular bushing 52 to rotate in an orthogonal direction relative to the encasement structure 72 as best shown in FIG. 6. Additionally, the annular ring 70 may serve to provide a damping effect for vibrational forces exerted on the railway car 10. That is, the annular ring 70 may isolate vibrational or impact energy from being transmitted to the end door 24 through the pivot assembly 30. In one embodiment, the resilient material from which the annular ring 70 is made may be rubber, neoprene, or other thermoplastic material having a compressibility such that the annular ring 70 may deform or change shape under stress. In one embodiment, the pivot assembly 30 may provide for approximately 7 degrees of orthogonal rotation during normal usage. Annular ring 70 made of a resilient material having a range of approximately 65 to 95 shore A in hardness may produce particularly advantageous results. In other embodiments, resilient materials having other shore A values may be used.

FIG. 7 is an exploded view showing the arrangement of the various components of the pivot assembly of FIG. 4. In one embodiment, bolts 78 may be provided that selectively secure the upper encasement structure 72a to the lower encasement structure 72b. In one embodiment, the bolts 78 may comprise weld studs that may be attached to the upper flange portion 60a via conventional welding techniques. In another embodiment, the bolts 78 may also selectively secure the upper 72a and lower 72b encasement structure to the top wall 16 of the railway car 10.

One embodiment provides for access to the various components of the pivot assembly 30 from one side of the pivot assembly 30. When the pivot assembly 30 is used in conjunction with a railway car 10/end door 24 assembly, access to the bearing 66, annular bushing 52, and annular ring 70 may be accomplished from inside the railway car 10. This feature may be provided by removal of nuts 80 from their associated bolts 78 as best shown in FIG. 8. The lower encasement portion 72b may serve as a lid to selectively cover the bearing 66, annular bushing 52, and annular ring 70. When the lower portion 72a is removed to access the various components, the upper encasement portion 72a may hold the pivot assembly 10 in place with bolts 80.

To access the various components of the pivot assembly 30 from inside the railway car 10, the nuts 80 may be removed from their associated bolts 78 in the normal manner. Next, the lower encasement portion 72b may be pulled downward for removal from the pivot assembly 30. After the lower encasement portion 72b has been removed, the annular ring 70, annular bushing 52, and bearing 66 may be removed by removing the bolt 76 and then applying a downward force upon the annular ring 70, annular bushing 52, and bearing 66. At this point, each of the various components may be inspected and replaced as desired. Installation of the lower portion 72b, annular ring 70, annular bushing 52, and bearing 66 may be accomplished by reversal of the aforedescribed procedure.

In one embodiment, a hole 82 may be provided in the lower encasement portion 72b to provide for periodic inspection as well as to provide for access to particular components of the pivot assembly 30. Visual inspection provided by the hole 82 may include inspection of the bolt 76 as well as to verify the overall concentricity of the pivot pin 54 relative to the hole 82. In one embodiment, the hole 82 is sufficiently large in diameter such that the bolt 76 and lower bearing 66b may be removed while the lower portion 72b remains secured to the pivot assembly 30. In this manner, the annular bushing 52 and annular ring 70 may be inspected without removal of the lower portion 72b. The hole 82 may also provide an outlet for water or other types of debris that may inadvertently collect within the encasement structure 72.

The hole 82 may have any suitable size. In one embodiment, the lower encasement portion 72b may not have a hole. In another embodiment, the hole 82 may be sufficiently small to prevent bolt 76 from passing through hole 82. In this manner, the bolt 76 may be maintained within the pivot assembly 30 in spite of inadvertently coming loose while configured on the railway car 10. For example, the hole 82 may be configured such that bolt 76 may only be “loosened” three turns before it contacts the surface of the lower encasement portion 72b.

One advantage that may be provided by certain embodiments is that the pivot pin 54 may remain pivotally coupled to the railway car 10 in spite of removal or disintegration of either of the annular ring 70, annular bushing 52, or bearing 66. This feature may be enabled by the arrangement of the pivot pin 54 relative to the upper encasement portion 72a. When the pivot assembly 30 is installed on a railway car 10, the pivot pin 54 extends through a hole 84 in the upper encasement portion 72a. If the annular ring 70, annular bushing 52, and/or bearing 66 are removed, the pivot pin 54 remains constrained within the hole 84 in which the hole 84 then forms a bearing surface for the pivot pin 54. Thus a failsafe condition may be provided in which failure of the annular ring 70, annular bushing 52, and/or bearing 66 may not cause detachment of the end door 24 from the railway car 10.

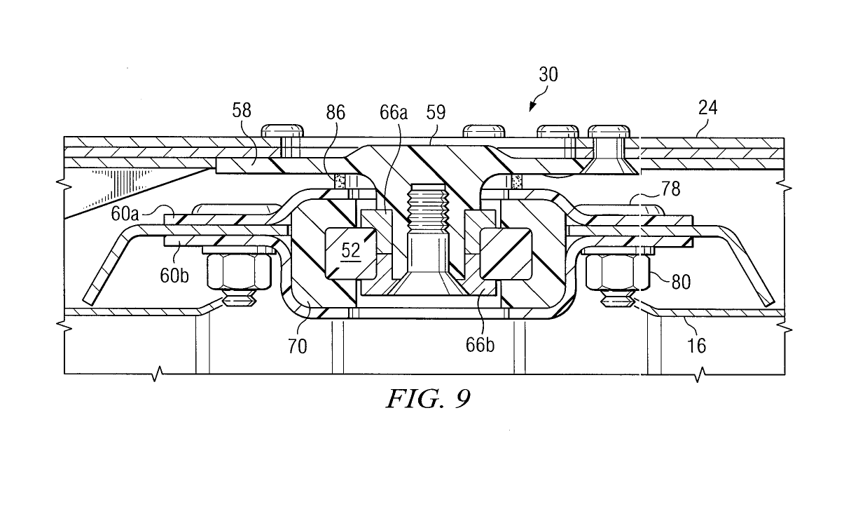

Optionally, a seal 86 may be provided as shown in FIG. 9. The seal 86 may be generally annular in shape and configured to extend around the pivot pin 54 and between the flange 58 and upper encasement portion 72a. The seal 86 may be formed of any deformable, water impermeable material such as an elongated section of closed-cell foam material that is formed into a ring. When disposed between the flange 58 and upper encasement portion 72a, the seal 86 may deform slightly such that a light pressure maintained for inhibiting water ingress to the pivot assembly 30 from the environment. The seal 86 may be attached to either the flange 58 or upper encasement portion 72a using any suitable adhesive. Thus, the various components of the pivot assembly 30 may be protected against the adverse effects caused by usage in an external environment. Additionally, the seal 86 may serve to inhibit the ingress of other forms of debris to the inside of the railway car 10, thereby protecting the cargo, such as automobiles stored inside.

FIG. 10 shows a series of actions that may be performed in order to implement the pivot assembly 30 of the present disclosure on a railway car 10. The particular actions described below are performed on an existing railway car 10 in which a pair of conventional pivot assemblies are replaced by a pair of pivot assemblies 30 according to the present disclosure. Nevertheless, it should be appreciated that a similar procedure may also be performed on new railway cars 10. In act 100, the method is initiated by performing any precursory actions, such as moving the railway car 10 to a location in which maintenance may be performed.

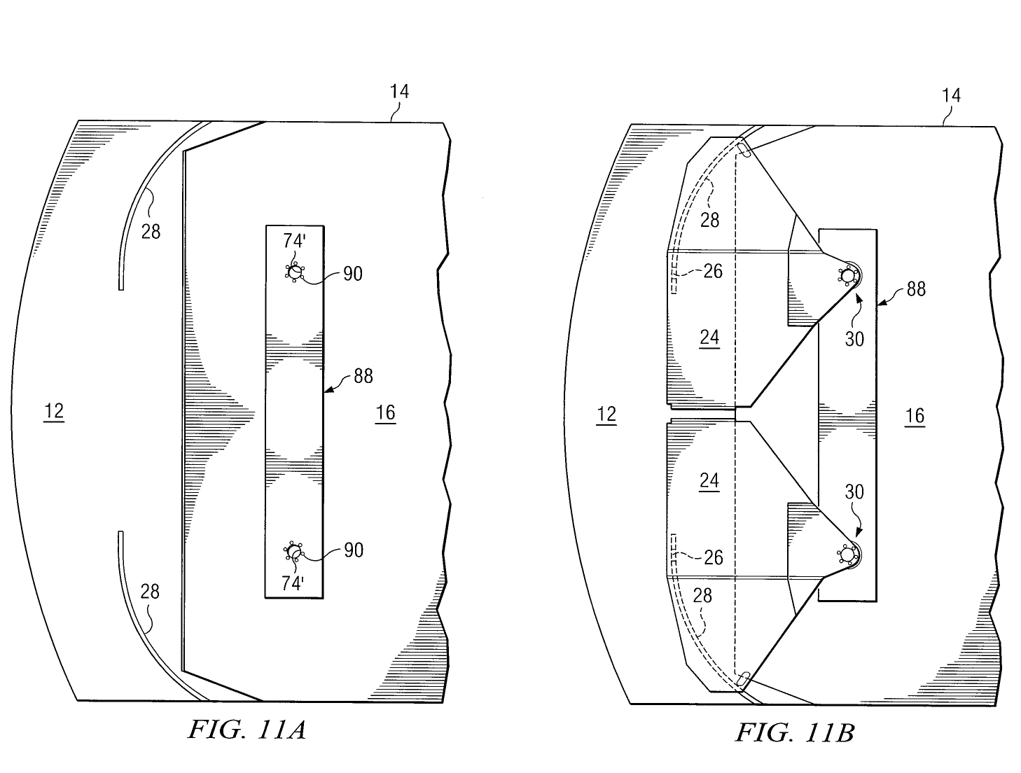

In act 102, the end doors 24 are removed from the railway car 10. In act 104, the holes 74 may be enlarged in order to allow placement of the encasement structure 72 of the pivot assembly 30 in the hole 74. In act 106, an optional elongated reinforcement channel 88 may be placed over the holes 74 and top wall 16 as best shown in FIG. 11A. In one embodiment, the reinforcement channel 88 may be provided with pre-drilled holes 74′ and bolt holes 90. In this manner, the pre-drilled holes 74′ and bolt holes 90 may function as a template to ensure that placement of the of the pivot assembly 30 on the top wall 16 is aligned in relatively consistent manner. Certain embodiments incorporating the reinforcement channel 88 may also provide an advantage in that forces exerted on the railway car 10 by the end doors 24 during use may be evenly distributed over a relatively large portion of the top wall 16.

In act 108, the pivot assembly 30 is secured to the top wall 16 using bolts 78 and their associated nuts 80. In act 110, the end doors 24 are secured to flanges 58 using any suitable attachment mechanism, such as rivets 62 described above. FIG. 11B shows the railway car of FIG. 11A in which the pivot assembly 30 has been successfully installed. In act 112, the pivot assembly 30 has been installed and the railway car 10 and its associated end doors 24 may be used in the normal manner.

Although an embodiment of the disclosure has been described using specific terms, such description is for illustrative purposes only. The words used are words of description rather than of limitation. It is to be understood that changes and variations may be made by those of ordinary skill in the art without departing from the spirit or scope of the present disclosure, which is set forth in the following claims. Therefore, the spirit and scope of the appended claims should not be limited to the description of the embodiments disclosed therein.

What is claimed is:

1. A pivot assembly, comprising:
a generally rigid annular bushing having a round-shaped hole defining a bushing axis;
a pivot pin fixedly coupled to a first flange having a surface that is generally perpendicular to a pivot pin axis of the pivot pin, the pivot pin extending through the round-shaped hole such that the bushing axis is maintained in fixed alignment with the pivot pin axis, the pivot pin having a removable bearing that couples the annular bushing to the pivot pin; and
a swivel coupler coupling the annular bushing to a second flange, the swivel coupler comprising:
an annular ring that is made of a resilient material such that the second flange may rotate in a direction that is orthogonal to the bushing axis; and
an encasement structure that houses the annular ring, the encasement structure being rigidly coupled to the second flange having an upper flange portion and a lower flange portion, the encasement structure being formed of an upper encasement portion and a lower encasement portion such that the upper encasement portion is integrally attached to the upper flange portion and the lower encasement portion is integrally attached to the lower flange portion.

2. The pivot assembly of claim 1, wherein the first flange is coupled to an end door and the second flange is coupled to a railway car.

3. The pivot assembly of claim 1, further comprising a through hole centrally configured in the lower encasement portion.

4. The pivot assembly of claim 1, further comprising a ring-shaped seal centrally disposed around the axis of the pivot pin and disposed between the upper encasement portion and the first flange.

5. A pivot assembly, comprising:
a generally rigid annular bushing having a round-shaped hole defining a bushing axis;
a pivot pin fixedly coupled to a first flange having a surface that is generally perpendicular to a pivot pin axis of the pivot pin, the pivot pin extending through the round-shaped hole such that the bushing axis is maintained in fixed alignment with the pivot pin axis; and
a swivel coupler coupling the annular bushing to a second flange, the swivel coupler comprising an annular ring that is made of a resilient material such that the second flange may rotate in a direction that is orthogonal to the bushing axis.

6. The pivot assembly of claim 5, wherein the pivot pin has a removable bearing, the removable bearing coupling the annular bushing to the pivot pin.

7. The pivot assembly of claim 6, wherein the removable bearing has two ends that are each attached to a lobe for inhibiting linear movement of the annular bushing relative to the pivot pin axis.

8. The pivot assembly of claim 5, wherein the swivel coupler further comprises an encasement structure that houses the annular ring, the encasement structure being rigidly coupled to the second flange.

9. The pivot assembly of claim 8, wherein the encasement structure is formed of an upper encasement portion and a lower encasement portion and the second flange has an upper flange portion and a lower flange portion, the upper encasement portion being rigidly attached to the upper flange portion and the lower encasement portion being rigidly attached to the lower flange portion.

10. The pivot assembly of claim 9, further comprising a through hole centrally configured in the lower encasement portion.

11. The pivot assembly of claim 9, wherein the lower encasement portion has a greater height than the upper encasement portion.

12. The pivot assembly of claim 9, further comprising a ring-shaped seal centrally disposed around the axis of the pivot pin and disposed between the upper encasement portion and the first flange.

13. The pivot assembly of claim 5, wherein the annular bushing is made of nylon.

14. The pivot assembly of claim 5, wherein the first flange is coupled to an end door and the second flange is coupled to a railway car.

15. The pivot assembly of claim 14, wherein the first flange is coupled to the end door using rivets.

16. The pivot assembly of claim 14, wherein the railway car is configured to transport automobiles.

17. A pivot assembly for a railway car, comprising:
a generally rigid annular bushing having a round-shaped hole defining a bushing axis;
a pivot pin fixedly coupled to a first flange having a surface that is generally perpendicular to a pivot pin axis of the pivot pin, the first flange being coupled to an end door of the railway car, the pivot pin extending through the round-shaped hole such that the bushing axis is maintained in fixed alignment with the pivot pin axis; and
a swivel coupler coupling the annular bushing to a second flange, the second flange being coupled to the railway car, the swivel coupler comprising an annular ring that is made of a resilient material such that the second flange may rotate in a direction that is orthogonal to the bushing axis.

18. The pivot assembly of claim 17, wherein the pivot pin has a removable bearing, the removable bearing coupling the annular bushing to the pivot pin.

19. The pivot assembly of claim 18, wherein the removable bearing has two ends that are each attached to a lobe for inhibiting linear movement of the annular bushing relative to the pivot pin axis.

20. The pivot assembly of claim 17, wherein the swivel coupler further comprises an encasement structure that houses annular ring, the encasement structure being rigidly coupled to the second flange.

21. The pivot assembly of claim 20, wherein the encasement structure is formed of an upper encasement portion and a lower encasement portion and the second flange has an upper flange portion and a lower flange portion, the upper encasement portion being rigidly attached to the upper flange portion and the lower encasement portion being rigidly attached to the lower flange portion.

22. The pivot assembly of claim 21, further comprising a through hole centrally configured in the lower encasement portion.

23. The pivot assembly of claim 21, wherein the lower encasement portion has a greater height than the upper encasement portion.

24. The pivot assembly of claim 21, further comprising a ring-shaped seal centrally disposed around the axis of the pivot pin and disposed between the upper encasement portion and the first flange.

25. The pivot assembly of claim 17, wherein the annular bushing is made of nylon.

26. The pivot assembly of claim 17, wherein the first flange is coupled to the end door using rivets.

27. The pivot assembly of claim 17, wherein the railway car is configured to transport automobiles.

28. A method for installing a pivot assembly on a railway car, comprising:
placing an elongated reinforcement channel over a top wall of the railway car, the reinforcement channel extending over a pair of pivot assembly holes that are each configured to allow placement of a corresponding pair of pivot assemblies therein;
securing the pair of pivot assemblies to the reinforcement channel and the top wall of the railway car; and
securing each of a pair of end doors to each of the pair of pivot assemblies.

29. The method of claim 28, wherein the reinforcement channel further comprises a plurality of first bolt holes, the method further comprising, following placement of the elongated reinforcement channel over the top wall, forming a plurality of second bolt holes in the top wall, each of the plurality of second bolt holes corresponding to the relative location of each of the plurality of first bolt holes.

30. The method of claim 28, further comprising, prior to placing an elongated reinforcement channel over the top wall, removing a pair of conventional pivot assemblies from the railway car and enlarging each of the pair of pivot assembly holes.
